(19) United States
(12) Patent Application Publication
(10) Pub. No.: US 2010/0132241 A1
(43) Pub. Date: Jun. 3, 2010

(54) Method for accurizing a firearm

(76) Inventor: Ralph J. Mancini, Danbury, CT (US)

Correspondence Address: Ralph J. Mancini, 16 Round Hill Drive, Darbury, CT, 06811, US

(21) Appl. No.: 12/454,425

(22) Filed: May 18, 2009

Related U.S. Application Data
(63) Continuation-in-part of application No. 12/152,948, filed on May 19, 2008.

(51) Int. Cl. F41A 21/22; B05D 1/18; B05D 1/02

(52) U.S. Cl. 42/76.02; 427/430.1; 427/421.1

(57) ABSTRACT

The present invention relates to an improved method of decreasing barrel resonance of a firearm upon firing, which greatly increases the accuracy thereof, produces tighter groupings, and reduces flash, report, and recoil. In order to achieve improved firearm accuracy, the firearm barrel is coated with a sound barrel resonance dampening material in the form of a tough, energy absorbing elastomeric coating.

### FIELD OF THE INVENTION

The claimed invention generally provides for a method of accurizing a firearm. More specifically, the invention provides for a method of decreasing barrel resonance of a firearm upon firing same thereby increasing the accuracy thereof.

### BACKGROUND OF THE INVENTION

Accurizing is a process of improving the accuracy of a firearm. Accuracy generally is dependent on three different areas: usability, tolerance and harmonics. While the present application is generally applicable to and affects all three areas, it is primarily related to improving the harmonics of a firearm.

Barrels vibrate or resonate under the shock of firing. Barrel jump or resonance is known to produce hunter discomfort and to diminish accuracy. Accordingly, various methods have been suggested to control resonance in the art.

U.S. Pat. No. 5,661,255 to Webb, III, discloses a weapon barrel oscillation reduction apparatus including a plurality of donut shaped rings or washers mounted on the muzzle end portion of a weapons barrel. The weapon barrel has breech and muzzle end portions and provides a machined ring carrying outer surface at the muzzle end portion. An annular shoulder at one end portion of the ring carrying portion acts as a stop for the plurality of rings mounted thereon. A retainer is removably attached to the opposite end of the ring carrying surface. On assembly, the rings can move slightly in a longitudinal direction with respect to each other during a firing of a projectile from the weapons barrel, where the weight of the rings and the slight movement of the rings function to reduce barrel oscillation.

U.S. Pat. No. 4,913,031 to Bossard et al. discloses a vibration damping device for improving the hit accuracy of a firing weapon. With firearm barrels, which are only secured at one of their ends at the weapon housing during firing of the weapon there occurs, particularly during series firing, bending vibrations or oscillations which impair the hit probability of the fired projectiles. In order to preclude or at least dampen such bending vibrations of the weapon barrel the invention contemplates securing a vibration damping device or damper at the muzzle of the weapon barrel. This vibration damper comprises an inertia body, which is resiliently connected with the weapon barrel muzzle. Also provided is a brake device, which dampens the movement of the inertia body relative to the weapon barrel. The inertia body preferably comprises two ring members which are pressed by springs against two disc members which are rigidly attached to the weapon barrel muzzle. Between the weapon barrel and the ring members of the inertia body there are arranged resilient elements, such as blade or leaf springs.

U.S. Pat. No. 6,664,456 to Momchilovich discloses a harmonic vibration damping device for musical instruments and firearms. More specifically, resilient material and/or rubber O-rings are placed at various predetermined locations to reduce unwanted sympathetic vibrations on musical instruments and firearms. This improves the performance and sound of musical instruments and makes them easier to play. The resilient material improves shooting accuracy, produces tighter groupings, and reduces flash, report and recoil of firearms.

However, there is a need in the art to decrease barrel resonance on firing of a firearm is in order to reduce the audible report and to increase accuracy.

### SUMMARY OF THE INVENTION

The present inventor has discovered an improved method of decreasing barrel resonance of a firearm upon firing, which greatly increases the accuracy thereof, produces tighter groupings, and reduces flash, report, and recoil. In order to achieve improved firearm accuracy, the firearm barrel is coated with a sound barrel resonance dampening material in the form of a tough, energy absorbing elastomeric coating. The invention also relates to a firearm produced from the claimed method.

### DETAILED DESCRIPTION OF THE INVENTION

The present invention generally provides for a method of substantially decreasing barrel resonance of a firearm upon firing of same thereby increasing the accuracy thereof The prior art describes various apparatus designed to diminish barrel resonance, but these devices are inadequate in part because the only cover a small portion of the surface area of the firearm barrel.

In accordance with the present invention, barrel resonance is substantially diminished because a substantial part of the surface area of the firearm barrel, and optionally the receiver, forend and/or stock of said firearm is coated with a barrel resonance dampening material in the form of a tough, energy absorbing elastomeric coating. This material effectively dampens excess energy generated during the firing of a firearm thereby decreasing barrel resonance of a firearm upon firing, which greatly increases the accuracy thereof, produces tighter groupings, and reduces flash, report, and recoil. Since more of the surface area is covered with the elastomeric material of the invention, the de-resonance effect is far superior to that of prior art devices. By reducing barrel resonance and vibrations due to the shot, even as the bullet travels down the barrel, the elastomeric coating increases the accuracy of the shot and aids in target acquisition due to its ability to reduce barrel jump.

The coating of the invention also enhances usability of the firearm as it provides a soft feel and sure grip to the firearm. It also provides an insulating layer in colder weather. Additionally, it provides tighter tolerances that what is ordinarily achievable when all surfaces are coated. Alternatively, one can only coat exposed surfaces.

In one embodiment, the elastomeric material coating is permanently bonded to the firearm barrel. This coating can be applied by dipping, spraying, painting, molding, or in any other manner evident to one of ordinary skill in the art.

The elastomeric coating can be used with any particular firearm, whether a shotgun, pistol or rifle, although particularly good results are observed in firearms having free floating barrels.

The elastomeric material useful in the context of the invention can be any material with the capacity to absorb or dampen barrel resonance on firing. Such coating should be durable and also have the ability to be conveniently and economically attached or permanently bonded to firearm barrels, and optionally receivers, actions, stocks, and the like. The elastomeric coating can also impart an insulating attribute to the firearm, and a noise reduction feature should the firearm barrel be struck against a hard object in the field.

In one embodiment, at least 70% of the surface area of the barrel is coated with said elastomeric material. In another embodiment, at least 80% of the surface area of the barrel is coated with said elastomeric material. In still another embodiment, embodiment, at least 90% of the surface area of the barrel is coated with said elastomeric material. In another embodiment, substantially all of the surface area of said barrel is coated with said elastomeric material. In another embodiment, all of the exposed surface area of said barrel is coated, and is still another embodiment, all of the surface area of said barrel is coated with said elastomeric material.

“Elastomer” and “elastomeric” are words of art. Elastomers are polymeric materials which can be rapidly stretched to their elastic limit (typically 200-1000 or more percent) and which snap or rebound to their original shape and dimensions when the “stretching” force is removed. Elastomers are thus defined in terms of their physical properties. Elastomeric is the adjective counterpart of, and has essentially the same meaning as, elastomer. The selected elastomeric material may or may not be viscoelastic. If it is, the response of the material to the imposed load arising from shock and vibration will have both viscous and elastic qualifiers.

Examples of elastomeric materials useful in the context of the invention include, but are not limited to, rubber, elastomeric rubbers, elastic and/or vinyl (co)polymers, rubber copolymers, polyurethane, e.g., Sorbothane™ (Sorbothane Inc., Kent, Ohio), Navcom™ (Allsop/Sims Vibration, Bellingham, Wash.), Line-X™ (Line-X Protective Coatings), or Tuff Stuff® (Rhino Linings and Coatings, Tualatin, Oreg.), viscoelastic rubber such as Smactane®, Smacsonic® (SMAC, Branly, France), polyurea coatings such as Duracoat™ (DuraCoat America), styrene-butadiene-styrene-, styrene ethylene/butylene-styrene, styrene-ethylene/propylene-styrene, styrene-isoprenestyrene, polyisoprene, ethylene-propylene diene rubbers (EPDM), chlorinated rubbers, nitrile rubbers, methylmethacrylate styrene-butadiene block copolymers, polybutadiene, acrylonitrile-butadiene-styrene copolymers, rubber acrylic (co)polymers and so forth, just to mention a few. Any of these materials can be optionally crosslinked, if necessary to meet the performance and durability standards of the present invention.

Additionally, certain thermosetting polymeric materials can meet the requirements of the vibration and/or noise abating material of the present invention. Examples of such materials include, but are not limited to unsaturated polyesters, epoxy resins, vinyl ester resins, phenolic resins, polyether, polyester and polyurea urethanes, urethane-acrylic composites arid/or materials, and the like. Such materials can advantageously be crosslinked with styrene, amines, vinyl toluene, hexamethylenetetramine, and the like.

Examples of such vibration and/or noise abating material materials useful in the context of the present invention abound in the prior art. For example, useful coatings are disclosed in the following U.S. Patents, which are all incorporated herein by reference” U.S. Pat. No. 5,084,521; U.S. Pat. No. 5,739,194; U.S. Pat. No. 5,096,962; U.S. Pat. No. 4,692,382; U.S. Pat. No. 5,114,783; U.S. Pat. No. 3,661,622; U.S. Pat. No. 5,532,025; U.S. Pat. No. 4,282,123; U.S. Pat. No. 5,169,922; U.S. Pat. No. 5,254,395; U.S. Pat. No. 5,346,112; and U.S. Pat. No. 6,942,586, U.S. Pat. No. 5,653,643, U.S. Pat. No. 5,944,617, U.S. Pat. No. 6, 126, 999 and U.S. Pat. No. 5,021,507.

The coating of the present invention can be applied in one layer or in multiple layers of the same or alternating materials, with or without an adhesive, depending on the materials and conditions chosen. The coating should be of minimal thickness necessary to achieve the desired dampening characteristics. In one embodiment, the coating can have an intermediate layer preferably made from a force dissipating or stiffening material such as aramid fibers, fiberglass materials, and the like. The surface of the coating can optionally include a gripping layer, optionally contain grit or other material for sure grip and/or an irregular surface contours for stealthy purposes.

Additionally, the coating of the invention can be clear or optionally contain a color tint or camo pattern. As deer have been proven to be able to discern uv light/brighteners, the coating employed can also contain uv suppressing and/or modifying materials and/or pigments thereby rendering the firearm invisible or nearly invisible to deer and other animals able to discern objects in this light spectrum. The tough durable coatings of the invention also protect the firearm from the harsh elements encountered by hunters and shooters alike.

While the invention has been described in the more limited aspects of the preferred embodiments thereof, other embodiments have been suggested and still others will occur to those skilled in the art upon reading and understanding the foregoing specification. It is intended that all such embodiments be included within the scope of this invention.

I claim:

1. A firearm comprising a barrel having reduced resonance on firing, wherein said barrel is coated with an elastomeric material having an enhanced ability to absorb barrel resonance.

2. The firearm of claim 1 wherein said firearm is a rifle, pistol, or shotgun.

3. The firearm of claim 1 wherein in addition to said barrel, the firearm receiver and/or stock is additionally coated with said elastomeric material.

4. The firearm of claim 1 wherein at least 70% of the surface area of the barrel is coated with said elastomeric material.

5. The firearm of claim 1 wherein substantially all of the surface area of said barrel is coated with said elastomeric material.

6. The firearm of claim 1 wherein said elastomeric material comprises a viscoelastic material, a thermosetting polymeric material, and mixtures thereof, wherein said materials are optionally crosslinked.

7. The firearm of claim 1 wherein said energy absorbing and/or dampening material is optionally crosslinked and is chosen from rubber, elastomeric polymers, elastomeric rubber, elastic and/or vinyl (co)polymers, rubber copolymers, polyurethane, viscoelastic rubber polyurea coatings, styrene-butadiene-styrene-, styrene-ethylene/butylene-styrene, styrene-ethylene/propylene-styrene, styrene-isoprenestyrene, polyisoprene, ethylene-propylene diene rubbers, chlorinated rubbers, nitrile rubbers, methylmethacrylate styrene-butadiene block copolymers, polybutadiene, acrylonitrile-butadiene-styrene copolymers, rubber acrylic (co)polymers, unsaturated polyesters, epoxy resins, vinyl ester resins, phenolic resins, polyether, polyester and polyurea urethanes, urethane-acrylic composites, and mixtures thereof.

8. The firearm of claim 7 wherein energy absorbing and/or dampening material is crosslinked with styrene, amines, vinyl toluene, hexamethylenetetramine, and mixtures thereof.

9. The firearm of claim 1 wherein said energy absorbing and/or dampening material is applied in the form of a coating, wherein said coating is formed in a single layer or in multiple layers, wherein said layers comprise the same or different energy absorbing and/or dampening materials.

10. The firearm of claim 9 wherein said energy absorbing and/or dampening material coating comprises an intermediate layer that comprises a stiffening material.

11. The firearm of claim 10 wherein said stiffening layer comprises aramid fibers, fiberglass fibers, or mixtures thereof.

12. The firearm of claim 1 wherein said elastomeric material additionally comprises one or more of a gripping additive, uv dampener, uv modifier, color tint, and camo pattern.

13. A method for accurizing a firearm, said method comprising coating the barrel of said firearm with an elastomeric material having an enhanced ability to absorb barrel resonance upon discharge of said firearm, thereby improving the accuracy thereof.

14. The method of claim 13 wherein said elastomeric material is applied in the form of a coating, said coating is formed in a single layer or in multiple layers, wherein said layers comprise the same or different elastomeric materials.

15. The method of claim 13 wherein said elastomeric material is optionally crosslinked and is chosen from rubber, elastomeric polymers, elastomeric rubber, elastic and/or vinyl (co)polymers, rubber copolymers, polyurethane, viscoelastic rubber polyurea coatings, styrene-butadiene-styrene-, styrene-ethylene/butylene-styrene, styrene-ethylene/propylene-styrene, styrene-isoprenestyrene, polyisoprene, ethylene-propylene diene rubbers, chlorinated rubbers, nitrile rubbers, methylmethacrylate styrene-butadiene block copolymers, polybutadiene, acrylonitrile-butadiene-styrene copolymers, rubber acrylic (co)polymers, unsaturated polyesters, epoxy resins, vinyl ester resins, phenolic resins, polyether, polyester and polyurea urethanes, and mixtures thereof.

16. The method of claim 13 wherein energy absorbing and/or dampening material additionally comprises one or more of a gripping additive, uv dampener, uv modifier, color tint, and camo pattern.

17. The method of claim 13 wherein said firearm is a rifle, pistol, or shotgun.

18. The method of claim 13 wherein in addition to said barrel, the firearm receiver and or stock is additionally coated with said elastomeric material.

19. The method of claim 13 wherein at least 70% of the surface area of the barrel is coated with said elastomeric material.

20. The method of claim 13 wherein substantially all of the surface area of said barrel is coated with said elastomeric material.
